(19) United States
(12) Patent Application Publication
(10) Pub. No.: US 2015/0120350 A1
(43) Pub. Date: Apr. 30, 2015

(54) METHOD AND SYSTEM FOR RECOMMENDING ONE OR MORE CROWDSOURCING PLATFORMS/WORKFORCES FOR BUSINESS WORKFLOW

(71) Applicant: Xerox Corporation, Norwalk, CT (US)

(72) Inventors: Sujit Gujar, Bangalore (IN); Shailesh Vaya, Bangalore (IN)

(73) Assignee: XEROX CORPORATION, Norwalk, CT (US)

(21) Appl. No.: 14/061,785

(22) Filed: Oct. 24, 2013

(51) Int. Cl. G06Q 10/06

(52) U.S. Cl. CPC G06Q 10/063112
USPC 705/7.14

(57) ABSTRACT

A method and system for recommending at least one of one or more workforces or crowdsourcing platforms for a business workflow is provided. The business workflow includes one or more tasks. The method includes receiving a plurality of business requirements corresponding to the business workflow. The method further includes receiving one or more attributes associated with at least one of the one or more of the workforces or the crowdsourcing platforms. Thereafter, at least one of the one or more workforces or the crowdsourcing platforms are recommended for each of the one or more tasks of the business workflow based on the plurality of business requirements and the one or more attributes.

### TECHNICAL FIELD

The presently disclosed embodiments are related to a crowdsourcing process. More particularly, the presently disclosed embodiments are related to a method and a system for recommending workforce or crowdsourcing platform(s) for a business workflow.

### BACKGROUND

Crowdsourcing has emerged over the last few years as an important labor pool for a business process. The primary factors for crowdsourcing the business process are controlling and reducing operating costs, non-availability of internal resources to handle certain operations, 24/7 access, and better turnaround time. Majority of crowdsourcing decisions are based on a cost benefit analysis, however, it could be possible that the workforce may not be suitable for completing tasks that are sent to it in a manner that meets all the requirements of the given business process. Hence, there is a need for a technique to identify the most suitable workforce for a business workflow.

### SUMMARY

According to embodiments illustrated herein, there is provided a method for recommending at least one of one or more workforces or crowdsourcing platforms for each of one or more tasks of a business workflow. The method includes receiving a plurality of business requirements corresponding to the business workflow. The method further includes receiving one or more attributes associated with at least one of the one or more workforces or the crowdsourcing platforms. Thereafter, at least one of the one or more workforces or the crowdsourcing platforms is recommended for each of the one or more tasks of the business workflow based on the plurality of business requirements and the one or more attributes. The method is performed by one or more processors.

According to embodiments illustrated herein, there is provided a system for recommending at least one of one or more workforces or crowdsourcing platforms for each of one or more tasks of a business workflow. The system includes a processing unit and a memory. The memory includes a communication module and a recommender module. The communication module is configured to receive a plurality of business requirements corresponding to the business workflow, and one or more attributes associated with at least one of the one or more workforces or the crowdsourcing platforms. The recommender module is configured to recommend at least one of the one or more workforces or the crowdsourcing platforms for each of the one or more tasks of the business workflow based on the plurality of business requirements and the one or more attributes, wherein each of the above steps is executed by the processing unit.

According to embodiments illustrated herein, there is provided a computer program product for use with a computer. The computer program product includes a non-transitory computer readable medium. The non-transitory computer readable medium stores a computer program code for recommending at least one of one or more workforces or crowdsourcing platforms for each of one or more tasks of a business workflow. The computer program code is executable by one or more processors to receive a plurality of business requirements corresponding to the business workflow. The computer program code is further executable by the one or more processors to receive one or more attributes associated with at least one of the one or more workforces or the crowdsourcing platforms. The computer program code is further executable by the one or more processors to recommend at least one of the one or more workforces or the crowdsourcing platforms for each of the one or more tasks of the business workflow based on the plurality of business requirements and the one or more attributes.

### BRIEF DESCRIPTION OF DRAWINGS

The accompanying drawings illustrate various embodiments of systems, methods, and embodiments of various other aspects of the invention. Any person with ordinary skills in the art will appreciate that the illustrated element boundaries (e.g., boxes, groups of boxes, or other shapes) in the figures represent one example of the boundaries. In a few examples, one element may be designed as multiple elements or multiple elements may be designed as one element. In a few examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 illustrates a block diagram of a system environment in which various embodiments can be implemented;

FIG. 2 is a block diagram illustrating a system for recommending at least one of one or more workforces or crowdsourcing platforms for a business workflow, in accordance with at least one embodiment;

FIG. 3 is a flow diagram that illustrates a method for recommending at least one of one or more workforces or crowdsourcing platforms for a business workflow, in accordance with at least one embodiment; and

FIGS. 4A, 4B, 4C, and 4D illustrate a series of flow diagrams in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are for explanatory purposes, as methods and systems may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definition: The following terms shall have, for the purposes of this application, the respective meaning set forth below.

A “computing device” refers to a computer or a device, including a processor/microcontroller and/or any other electronic component, device, or system that performs one or more operations according to one or more programming instructions. Examples of the computing device include, but are not limited to, a desktop computer, a laptop, a personal digital assistant (PDA), a Smartphone, and the like. The computing device is capable of accessing (or being accessed over) a network (e.g., using wired or wireless communication capabilities).

A “network” refers to a medium that interconnects servers and various computing devices. Examples of the network include, but are not limited to, LAN, WLAN, MAN, WAN, and the Internet. The communication over the network may be performed in accordance with various communication protocols, such as Transmission Control Protocol and Internet Protocol (TCP/IP), User Datagram Protocol (UDP), and IEEE 802.11 n communication protocols.

“Crowdsourcing” refers to distributing tasks by soliciting the participation of loosely defined groups of individual users. A group of users may include, for example, individuals responding to a solicitation posted on a certain website, such as Amazon Mechanical Turk and Crowd Flower.

A “business workflow” refers to a process that includes plurality of tasks, or one or more activities that a business implements in order to achieve a specific business result. In an embodiment, the business workflow may have multiple paths, traversing which the tasks may be performed in order to achieve the desired outcome. Further, in an embodiment, the graph of the business workflow is a directed acyclic graph (DAG).

Attributes refer to one or more parameters which are of concern to the business process owner and which the business process owner wants to optimize. In an embodiment, the examples of attributes include, but are not limited to, cost, accuracy, throughput, delay, etc. Further, in an embodiment, the one or more attributes associated with the workforce (workers) or the crowdsourcing platforms are provided by the business process owner.

“Business requirement” refers to information provided by the business process owner to achieve a desired set of results post execution of the workflow. In an embodiment, the business requirement may correspond to at least one of a technology requirement, a labor requirement, or a process requirement. The technology requirement corresponds to one or more of internet bandwidth, number of computers, number of servers, propriety software, power supply, power back up, access card protected, hard disks with PGP encryption, firewall protection, or the like. The labor requirement corresponds to one or more of number of employees, cost per employee, education of employee, size of employee pool, training cost, training time, transportation cost, employee skill set such as typing speed, language, domain knowledge, or the like. The process requirement corresponds to one or more of average speed, average job quality, accuracy, end-to-end delay, collaboration, or the like. Further, in an embodiment, the business requirements corresponding to the workflow may include the information, such as SLAs to be achieved in the workflow, path in the workflow which is of interest to the business process owner, weights assigned to various attributes such as cost, accuracy, throughput, delay, etc., and so forth.

A “Workforce” refers to one or more worker(s) that may perform one or more tasks, which generate data that contribute to a defined result such as proofreading a part of a digital version of an ancient text or analyzing a quantum of a large volume of data. Each crowdworker is further compensated for the contribution on the task. According to the present disclosure, the workforce includes, but is not limited to, a satellite centre employee, a rural Business Process Outsourcing (BPO) firm employee, a home-based employee, or an internet-based employee. Hereinafter, “workforce”, “crowdworker”, and “crowd” may be interchangeably used.

A “task” refers to a piece of work, an activity, an action, a job, an instruction or an assignment to be performed. Tasks may necessitate the involvement of one or more workers. Examples of tasks may include, but are not limited to, digitization of a document, generating a report, evaluating a document, conducting a survey, writing a code, extracting data, translating text, and so forth. The task includes task template and task features. The task template refers to a template that includes instructions about how to perform the tasks. Further, the task template may include data, or a link to the data, to be processed by the crowdworkers. The task feature refers to the properties associated with the one or more crowdsourcing tasks. Examples of the task features may include, but are not limited to, a day of submitting the task, a time in the day of submitting the task on crowdsource platform, a cost of the task, a country of submitting the task and so forth.

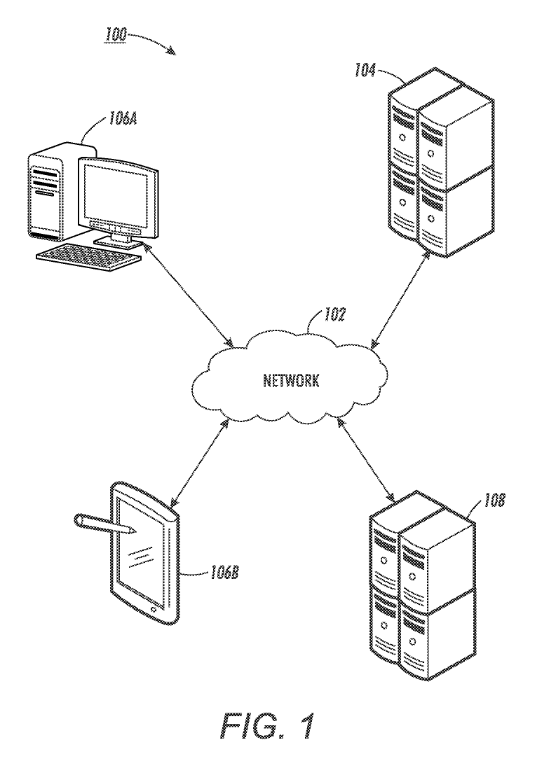

FIG. 1 is a block diagram illustrating a system environment 100 in which various embodiments may be implemented. The system environment 100 includes a network 102, a first server 104, a first computing device 106a (e.g., personal computer), a second computing device 106b (e.g., mobile phone), and a second server 108. Although FIG. 1 shows two computing devices for simplicity, the disclosed embodiments may be implemented for a large number of computing devices including, but not limited to, laptops, smartphones, PDAs, and various similar handheld devices.

The first server 104 corresponds to an application server. The application server is configured to generate the one or more tasks for completion through crowdsourcing. The application server uploads the one or more tasks on one or more crowdsourcing platforms. In an embodiment, the application server recommends at least one of one or more workforces or the crowdsourcing platforms for the business workflow. Some examples of the application server may include, but not limited to, Java application server, .NET framework, and Base4 application server.

In an embodiment, users of the first computing device 106a are hereinafter referred to as crowdworkers, crowd, or crowd workforce. In an embodiment, users of the second computing device 106b (hereinafter, referred to as a requestor) may submit various tasks pertaining to a business workflow to be crowdsourced in the one or more crowdsourcing platforms.

A user operating the first computing device 106a is capable of accessing the first server 104 workforce and/or the second server 108 through the network 102 or directly (i.e., physical access). The functionality of recommending of the at least one of the one or more workforces or the crowdsourcing platforms for the business workflow may be implemented on at least one of the first server 104, the first computing device 106a, the second server 108, or the second computing device 106b.

In an embodiment, the second server 108 is a crowdsourcing platform server that hosts the one or more crowdsourcing platforms and is interconnected to the first computing device 106a (a crowdworker computing device), the second computing device 106b (a requester computing device), and the first server 104 over the network 102. The crowdsourcing platforms accept tasks (hereinafter referred to as “crowdsourced tasks”) from the first computing device 106a and present the crowdsourced tasks to the second computing device 106b through web based interfaces. Examples of the one or more tasks include, but are not limited to, selection task, validation task, and the like.

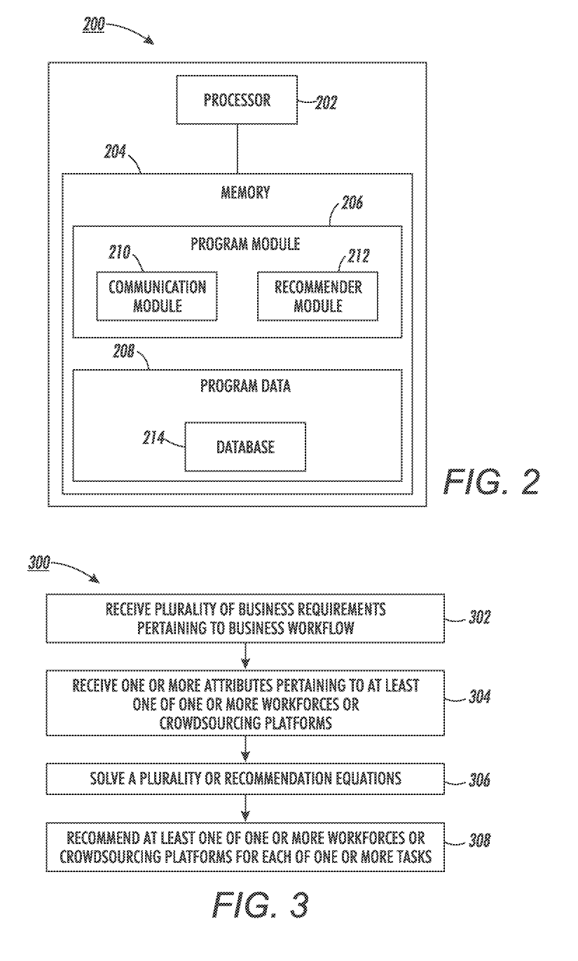

FIG. 2 is a block diagram illustrating a system 200 for recommending at least one of one or more workforces or crowdsourcing platforms for a business workflow, in accordance with at least one embodiment. The system 200 includes a processor 202 and a memory 204. The processor 202 is coupled with the memory 204. In an embodiment, the system 200 corresponds to a computing device such as, a PDA, a Smartphone, a tablet, a laptop, a personal computer, a mobile phone, and a Digital Living Network Alliance (DLNA)-enabled device. In an embodiment, the system 200 corresponds to the first server 104. A person skilled in the art would understand that the scope of the disclosure is not limited to the system 200 as the first server 104. In an embodiment, the system 200 may correspond to the second server 108.

The processor 202 is configured to execute a set of instructions stored in the memory 204. The processor 202 can be realized through a number of processor technologies known in the art. Examples of the processor 202 can be an X86 processor, a RISC processor, an ASIC processor, a CISC processor, or any other processor. The processor 202 gathers and executes the set of instructions from the memory 204.

The memory 204 is configured to store the set of instructions. Some of the commonly known memory implementations can be, but are not limited to, a Random Access Memory (RAM), a Read-Only Memory (ROM), a hard disk drive (HDD), and a secure digital (SD) card. The memory 204 includes a program module 206 and a program data 208. The program module 206 includes a set of instructions that can be executed by the processor 202 to perform specific actions on the system. The program module 206 includes a communication module 210 and a recommender module 212. The program data 208 includes a database 214.

The communication module 210 is configured to retrieve a plurality of business requirements corresponding to the business workflow from the database 214. In an embodiment, the plurality of business requirements include at least one of a measure of expected accuracy, a measure of expected time for completing the one or more tasks in the workflow, a measure of expected throughput, and a measure of expected cost. In an embodiment, each of the one or more tasks has one or more associated characteristics (e.g., a type of task). Based on the one or more associated characteristics (e.g., the type of the task), the one or more tasks may be categorized under one or more categories.

In an embodiment, the plurality of business requirements include, but are not limited to, a technology requirement, a labor requirement, and a process requirement. The technology requirement of the business workflow includes one or more of internet bandwidth, number of computers, number of servers, propriety software, power supply, power back up, access card protected, hard disks with PGP encryption, firewall protection, or the like. The labor requirement of the business workflow includes one or more of number of employees, cost per employee, education of employee, size of employee pool, training cost, training time, transportation cost, employee skill set such as typing speed, language, domain knowledge, and the like. The process requirement of the business workflow includes one or more of average speed, average job quality, accuracy, end-to-end delay, collaboration, and the like. Further, in an embodiment, the business requirements include the information, such as SLAs to be achieved in the workflow, path in the workflow that is of interest to the business process owner, weights assigned to various attributes such as cost, accuracy, throughput, delay etc. and so forth.

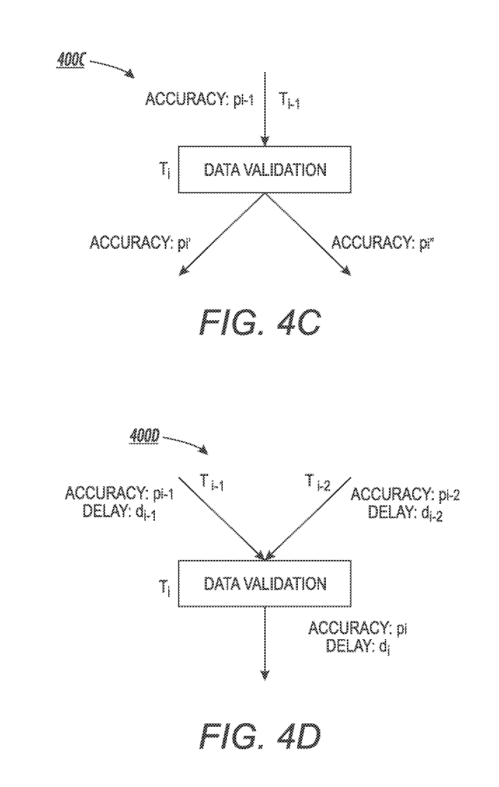

The communication module 210 is further configured to retrieve one or more attributes associated with the one or more sets of workforces or the crowdsourcing platforms from the database 214. For example, each set of the workforce has its own set of attributes such as defined skill profiles, cost corresponding to the set of workforce, delays corresponding to the set of workforce, throughput provided by the set of workforce and so forth. It will be understood by the person having ordinary skill in the art that the costs corresponding to the set of workforce imply the amount of money needed to complete a task through that set of workforce. Similarly, delay corresponding to the set of workforce implies the time taken by that set of workforce to complete a particular task. Further example of the one or more attributes associated with the one or more crowdworkers is discussed in conjunction with FIGS. 4A, 4B, 4C, and 4D.

The communication module 210 includes various protocol stacks such as, but not limited to, TCP/IP, UDP, and 2G, 3G, or 4G communication protocols. The communication module 210 transmits and receives the messages/data (e.g., images) in accordance with such protocol stacks.

The recommender module 212 is configured to recommend the at least one of the one or more workforces or the crowdsourcing platforms for each of the one or more tasks of the business workflow.

In an embodiment, the recommender module 212 receives the plurality of business requirements and the one or more attributes associated with the workforce/crowdsourcing platform from the communication module 210, and compares the plurality of business requirements against the one or more attributes of the one or more sets of the workforces. In an embodiment, the comparison of the plurality of business requirements of the business process with the one or more attributes of the one or more sets of workforces is done based on one or more comparison techniques known in the art. Thus, based on the results of the comparison, the recommender module 212 recommends the at least one of the one or more workforces or the crowdsourcing platform for each of the one or more tasks of the business workflow.

In another embodiment, the recommender module 212 is configured to solve a plurality of recommendation equations. In an embodiment, the plurality of recommendation equations are considered for recommending the at least one of the one or more workforces or the crowdsourcing platforms for a business workflow. The plurality of recommendation equations take into account variables such as cost, throughput, end-to-end delay, accuracy, etc., to recommend the one or more workforces or crowdsourcing platforms.

In an embodiment, in the business workflow, overall accuracy will depend on accuracies achieved for the one or more tasks in the business workflow. For each of the one or more tasks, the accuracy will depend on accuracy of data received from previous steps and accuracy of alternate workforce, which is going to perform a current task from the one or more tasks. For example, a workflow for validating digitized forms may include the one or more tasks such as receiving scanned forms, inputting data, validating the inputted data, and rejecting or accepting the inputted data based on validation. Each of the one or more tasks has an associated accuracy. Further, the accuracy of a first task in the one or more tasks is dependent on another task that preceded the first task. For instance, the accuracy of validating the inputted data is dependent on the task of inputting data.

In an embodiment, the recommender module 212 uses below equation to recommend the workforce/crowdsourcing platform:

maximize (−α₁cₖ+α₂fₖ−α₃dₖ+α₄pₖ) such that P₀−1 (1)

where,
cₖ=total cost for k tasks
fₖ=throughput (number of jobs per hour) for k tasks
dₖ=total end to end delay for k tasks
Pₖ=overall accuracy for k tasks
α₁: Weight assigned to cost cₖ
α₂: Weight assigned to throughput fₖ
α₃: Weight assigned to delay dₖ
α₄: Weight assigned to accuracy pₖ

In an embodiment, the accuracy (pᵢ), the throughput (f₁), the cost (cᵢ), and the delay (d₁) for the task Tᵢ are determined as, respectively:

pᵢ=Σⱼ₌₀^{L}Xᵢ^{j}*COMPUTE ACCURACYᵢ(pᵢ^{prev}, Cⱼ) ∀i (2)

fₖ≦Σⱼ₌₀^{L}Xᵢ^{j}*fᵢ^{j} ∀i (3)

cₖ=Σᵢ₌₀^{k}Σⱼ₌₀^{L}Xᵢ^{J}cᵢ^{j} (4)

dᵢ=dᵢ^{prev}+Σⱼ₌₀^{L}Xᵢ^{j}dᵢ^{j} (5)

where,

Xᵢ^{j} represents an indicator variable that is assigned value ‘1’ if task Tᵢ is assigned to platform Cⱼ and ‘0’ if task Tᵢ is not assigned to platform Cⱼ

COMPUTE ACCURACYᵢ represents the function that is used in determining the accuracy for the task Tᵢ

Further equations involved in the function COMPUTE ACCURACY have been discussed in conjunction with FIGS. 4A, 4B, 4C, and 4D.

The recommender module 212 compares the accuracy, the throughput, the cost, and the delay computed as per the equations (2), (3), (4), and (5), respectively, with the SLAs received from the business process owner. In an embodiment, to ensure that SLAs are met for the business workflow below provided inequalities are considered by the recommender module 212:

pₖ≧A_{T} (6)

fₖ≧F_{T} (7)

dₖ≦D_{T} (8)

where,
A_{T}=SLA for accuracy
F_{T}=SLA for number of jobs per hour (throughput)
D_{T}=SLA for turn-around-time (delay)

The recommender module 212 recommends at least one set of workforce from the one or more sets of the workforces suitable for working on the given business workflow to maximize profit and output quality. Thus, according to an embodiment, the recommender module 212 identifies whether a given business workflow is crowdsourcable to a given crowd or not. In an embodiment, the recommender module 212 indicates a suitable workforce among the set of workforce that matches the plurality of business requirements within the pre-specified tolerance values on the plurality of business requirements. In yet another embodiment, the recommender module 212 may recommend at least one crowdsourcing platform from a plurality of crowdsourcing platforms for working on the given business workflow to maximize profit and output quality.

In another embodiment, the recommender module 212 may also be configured to rank the one or more suitable set of the workforce/crowdsourcing platforms based on results of the comparison between the plurality of business requirements and attributes associated with the one or more sets of the workforces/crowdsourcing platforms. The rank is assigned to the suitable set of workforce/crowdsourcing platform based on pre-defined criteria.

The pre-defined criteria includes rules according to which each of the suitable set of workforce is assigned a numerical value on the basis of the degree of matching of the attributes associated with the workforce/crowdsourcing platform with the given business requirements from the plurality of business requirements of the business workflow to be crowdsourced. The numerical value assigned to the each of the suitable set of workforce defines a rank number for each of the suitable set of workforce/crowdsourcing platform for each of the one or more tasks of the business workflow.

In an embodiment, the database 214 corresponds to a storage device. The database 214 stores the plurality of business requirements, including the technology requirements, the labor requirements, and the process requirements. The database 214 is further configured to store the one or more attributes associated with the one or more sets of workforces, including the skill profile for each workforce. The database 214 can be implemented by using several technologies that are well known to those skilled in the art. Some examples of technologies may include, but are not limited to, MySQL® and Microsoft SQL®. In an embodiment, the database 214 may be implemented as cloud storage. Examples of cloud storage may include, but are not limited to, Amazon E3® and the Hadoop® distributed file system.

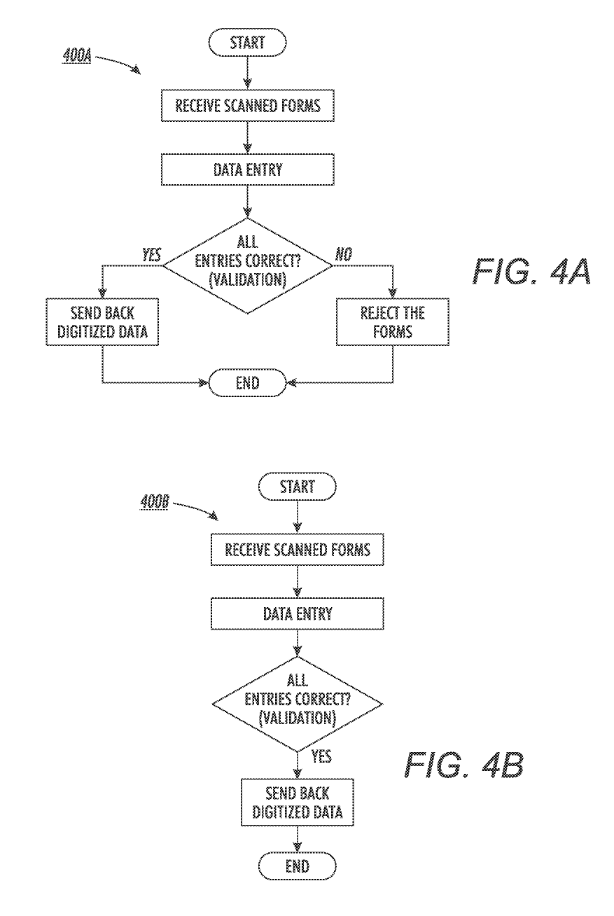

FIG. 3 is a flow diagram 300 illustrating a method for recommending the at least one of the one or more workforces or the crowdsourcing platforms for a business workflow in accordance with at least one embodiment.

At step 302, the plurality of the business requirements are received corresponding to the business workflow. In an embodiment, the plurality of the business requirements are received by the communication module 210 from the database 214 based on an input provided by an administrator of the system. In an embodiment, the administrator of the system can be a manager or owner of the business workflow.

At step 304, the one or more attributes associated with the one or more sets of workforces are received. In an embodiment, the one or more attributes are received by the communication module 210 from the database 214. In an embodiment, the one or more attributes include, but are not limited to, the skill profile of each workforce, cost corresponding to the set of workforce, delays corresponding to the set of workforce, throughput provided by the set of workforce and so forth.

In an embodiment, each business requirement is assigned a tolerance value. The tolerance value further defines the acceptable range for each business requirement to be matched with the attributes of crowdsourced workforce/workforce. For example, the requestor has defined that an accuracy of 80% ±5% is acceptable. Then ±5% is the tolerance range. A person skilled in the art would understand that the scope of the disclosure is not limited to assigning the tolerance range. In an embodiment, the tolerance range may not be assigned to each business requirement without departing from the scope of the disclosed embodiments.

At step 306, the plurality of recommendation equations are solved. The plurality of recommendation equations are based on the plurality of the business requirements and the one or more attributes associated with the set of workforce/crowdsourcing platforms. In an embodiment, the recommendation equations are solved by the recommender module 212.

At step 308, at least one of the one or more workforces or the crowdsourcing platforms is recommended for each of the one or more tasks of the business workflow. In an embodiment, the recommender module 212 recommends the at least one of the one or more workforces or the crowdsourcing platforms for each of the one or more tasks of the business workflow based on the results obtained after solving the recommendation equations. In an embodiment, the plurality of recommendation equations may be solved using a semi-definite program solver.

FIGS. 4A, 4B, 4C, and 4D illustrate a series of block diagrams 400a, 400b, 400c, and 400d, respectively, in accordance with at least one embodiment. The block diagram 400a illustrates a business workflow for validating data entries in scanned forms. In an embodiment, the data entries may be validated by crowdworkers or character recognizing software. As depicted in the block diagram 400a, two paths are available for the business workflow of validating data entries. The block diagram 400b illustrates the path of the business workflow that is of interest to the business process owner (this information is provided by the business process owner as a part of business requirement). In an embodiment three crowdworkers R1, R2, and R2 are available to perform different tasks in the business workflow for validating the data entries. The aim of the business process owner is to decide which task should be assigned to which crowdworker. The block diagram 400c and 400d correspond to the alternate embodiments where multiple paths are branching out and converging at the task of data validation (depicted by task Tᵢ), respectively.

In accordance with step 302, plurality of business requirements are received from the business process owner. The communication module 210 retrieves the business requirements from the database 214. In an embodiment, the business process owner specifies the path of the business workflow that is of interest to him (depicted by the block diagram 400b). Further, the business process owner specifies one or more SLAs associated with the workflow for validating the data entries. For example, the business process owner may specify that accuracy in the workflow should be at least 99%, that 5000 forms should be processed per hour, that time to validate the scanned digital copy should be 3 hrs, and the like. Further, the business process owner specifies the weights associated with each of the attributes (i.e. cost, throughput, delay, accuracy etc.). Table 1 provided below illustrates information provided by the business process owner as a part of business requirement:

TABLE 1
Illustration of the business requirement provided by
the business process owner.

| Attribute | SLAs | Weight |
|---|---|---|
| Cost | 0.5$ per form | 0.9 |
| Throughput | 5000 forms per hour | 0.7 |
| Delay | 3 hours per forms | 0.8 |
| Accuracy | 99% | 1.0 |

In accordance with step 304, one or more attributes associated with the crowdworkers R1, R2, and R3 are received. In an embodiment, the one or more attributes (e.g. cost, accuracy rate, throughput, delay etc.) provided by the business process owner are retrieved by the communication module 210 from the database 214. Table 2 provided below illustrates the one or more attributes associated with the crowdworkers R1, R2, and R3, as provided by the business process owner:

TABLE 2
Illustration of the one or more attributes associated with
the one or more workforces.

| Crowdworker | Accuracy | Delay | Cost |
|---|---|---|---|
| R1 | 95% | 2.5 hours per form | 0.5$ per form |
| R2 | 85% | 3.5 hours per form | 0.6$ per form |
| R3 | 90% | 3 hours per form | 0.45$ per form |

It will be understood by a person having ordinary skills in the art that the business process owner may provide similar attributes (as provided above for the crowdworkers R1, R2, and R3) corresponding to the one or more crowdsourcing platforms.

In accordance with step 306, the recommender module 212 solves the plurality of recommendation equations. In an embodiment, the recommender module 212 uses information provided in the Table 1 and Table 2 to solve the recommendation equations (1)-(8).

In accordance with step 308, the recommender module 212 recommends the crowdworkers (out of R1, R2, and R3) that should be assigned to different tasks in the business workflow for validating the data entries. In an embodiment, the recommender module 212 uses the equations (1)-(8) and the information available in Table 1 and Table 2 to recommend the crowdworkers such that SLAs provided by the business process owners are satisfied.

In an alternate embodiment, the business workflow for the validation of data entries has multiple paths branching out or converging at a particular task in the business workflow. The block diagram 400c depicts such a scenario where two paths are branching out at the task of validation (depicted as Tᵢ) in the business process workflow. The block diagram 400d depicts a scenario where two paths are converging at the task of validation (i.e., Tᵢ) in the business workflow.

As depicted in 400c, is the accuracy until the task Tᵢ₋₁ (i.e. the task of data entry). Further, the accuracies corresponding to the two task branching out from the task Tᵢ) are given by pᵢ′ and pᵢ″, respectively. In an embodiment, the accuracy for each path after the task Tᵢ is given by COMPUTE ACCURACYᵢ, which takes into account the accuracy of the data received until the task Tᵢ and the accuracy at the task Tᵢ itself.

As an example, if the accuracy at the task Tᵢ₋₁ (i.e., the data entry) is 90% and at the task Tᵢ (i.e., the data validation) is 95%, then the accuracy along each path of the block diagram 400c will be given by:

$$1 - Prob ( Data was wrongly accepted ) = 1 - Prob ( data was wrongly digitized and it was still validated ) = 1 - {Prob ( data entry had an error )}^{*} Prob ( validation had error ) = 1 - ( 1 - 0.9 ) * ( 1 - 0.05 ) = 0.995$$

Thus, generalizing the above example, the COMPUTE ACCURACYᵢ function for the business workflow (as depicted in the block diagram 400c) can be defined as:

1−(1−pᵢ₋₁)*(1−validation accuracy)

In a similar way, 400d depicts the scenario in the business workflow of validation of data entries, where multiple paths are converging at the task Tᵢ. As depicted in 400d, at the task Tᵢ, data comes from two tasks i.e. Tᵢ₋₁ and Tᵢ₋₂. The accuracies at the task Tᵢ₋₁ and Tᵢ₋₂ are given by and pᵢ₋₁ and pᵢ₋₂, respectively. The accuracy pᵢ₁ at the task Tᵢ can be determined as:

COMPUTE−ACCURACYᵢ(pᵢ^{prev}, Cⱼ)

where,

pᵢ^{prev}=min(pᵢ₋₁, pᵢ₋₂). i.e. pᵢ^{prev}≦pand pᵢ^{prev}≦p_{{i-2}}

In a similar way delay at the task Tᵢ can be determined for the business workflow. If the delays at the task Tᵢ₋₁ and the task Tᵢ₋₂ are dᵢ₋₁ and dᵢ₋₂, respectively, as depicted in 400d, then the delay di at the task Tᵢ will be given by:

dᵢ=dᵢ^{prev}+Σⱼ₌₀^{L}Xᵢ^{j}dᵢ^{j}.

where,

dᵢ^{prev}→max(dᵢ₋₁, d_{d}ᵢ₋₂) i. e. dᵢ^{prev}≦d_{d}ᵢ₋₁ and dᵢ^{prev}≧dᵢ₋₂

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices, which are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be RAM or ROM. The computer system further consists of a storage device, which may be an HDD or a removable storage drive, such as a floppy-disk drive or an optical-disk drive. The storage device may also be a means for loading computer programs or other instructions onto the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as LAN, MAN, WAN, and the Internet. The computer system facilitates inputs from a user through an input device, accessible to the system through the I/O interface.

The computer system executes a set of instructions that is stored in one or more storage elements to process input data. The storage elements may also hold data or other information, as desired. The storage element may be in the form of an information source or a physical memory element present in the processing machine.

The programmable or computer readable instructions may include various commands that instruct the processing machine to perform specific tasks such as steps that constitute the method of the disclosure. The method and systems described can also be implemented using only software programming or only hardware, or by a varying combination of the two. The disclosure is independent of the programming language and the operating system used in the computers. The instructions for the disclosure can be written in all programming languages including, but not limited to, ‘C’, ‘C++’, ‘Visual C++’, and ‘Visual Basic’. Further, the software may be in form of a collection of separate programs, a program module containing a larger program, or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in various operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, the system, and the computer program product, as described above, have numerous advantages. Some of these advantages may include, but are not limited to, reducing costs, increasing returns on investments, improving process performance, freeing up resources for other uses, converting fixed costs to variable costs, improving speed to market, 24/7 access to services, and better turnaround time of finished work products.

Various embodiments of the method and the system for recommending the at least one of the one or more workforces or the crowdsourcing platforms for the business workflow have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person with ordinary skill in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for recommending at least one of one or more workforces or crowdsourcing platforms for each of one or more tasks of a business workflow, the method comprising:
receiving, by one or more processors, a plurality of business requirements corresponding to the business workflow;
receiving, by the one or more processors, one or more attributes associated with at least one of the one or more workforces or the crowdsourcing platforms; and
recommending, by the one or more processors, at least one of the one or more workforces or the crowdsourcing platforms for each of the one or more tasks of the business workflow based on the plurality of business requirements and the one or more attributes.

2. The method of claim 1, wherein the business workflow has multiple paths, through which the one or more tasks can be processed.

3. The method of claim 1, wherein the plurality of business requirements comprise at least one of labor requirements, technology requirements, process requirements, service level agreements (SLAs) for the business workflow, weights assigned to the one or more attributes, or path of interest in the business workflow.

4. The method of claim 1, wherein the one or more attributes associated with at least one of the one or more workforces or the crowdsourcing platform comprise at least one of a cost, a delay, an accuracy, or a throughput.

5. The method of claim 3, wherein the labor requirements comprise at least one of labor education or labor integrity.

6. The method of claim 3, wherein the technology requirements comprise at least one of a number of servers, a number of computers, or a firewall protection.

7. The method of claim 3, wherein the process requirements comprise at least one of data integrity, compliance, time of completion, or quality insurance.

8. The method of claim 1 further comprising solving a plurality of recommendation equations, wherein the plurality of recommendation equations are based on the plurality of business requirements and the one or more attributes.

9. The method of claim 8, wherein the plurality of recommendation equations are solved using a semi-definite program solver.

10. The method of claim 8, wherein at least one of the one or more workforces or the crowdsourcing platforms for each of the one or more tasks of the business workflow is recommended based on the solutions of the plurality of recommendation equations.

11. The method of claim 1, wherein graph of the business workflow is a directed acyclic graph (DAG).

12. A system for recommending at least one of one or more workforces or crowdsourcing platforms for each of one or more tasks of a business workflow, the system comprising:
a memory comprising:
a communication module configured to receive a plurality of business requirements corresponding to the business workflow and one or more attributes associated with at least one of the one or more workforces or the crowdsourcing platforms and
a recommender module configured to recommend at least one of the one or more workforces or the crowdsourcing platforms for each of the one or more tasks of the business workflow based on the plurality of business requirements and the one or more attributes; and
one or more processors configured to execute the communication module and the recommendation module.

13. The system of claim 12, wherein the plurality of business requirements comprise at least one of labor requirements, technology requirements, process requirements, service level agreements (SLAs) for the business workflow, weights assigned to the one or more attributes, or path of interest in the business workflow.

14. The system of claim 12, wherein the one or more attributes associated with at least one of the one or more workforces or the crowdsourcing platforms comprise at least one of a cost, a delay, accuracy, or a throughput.

15. The system of claim 12, wherein the recommender module is further configured to solve a plurality of recommendation equations, wherein the plurality of the recommendation equations are based on the plurality of business requirements and the one or more attributes.

16. The system of claim 15, wherein the plurality of recommendation equations are solved using a semi-definite program solver.

17. The system of claim 15, wherein at least one of the one or more workforces or the crowdsourcing platforms for each of the one or more tasks of the business workflow is recommended based on the solutions of the plurality of recommendation equations.

18. The system of claim 12, wherein graph of the business workflow is a directed acyclic graph (DAG).

19. The system of claim 12, wherein the business workflow has multiple paths, through which the one or more tasks can be processed.

20. A computer program product for use with a computer, the computer program product comprising a non-transitory computer readable medium, wherein the non-transitory computer readable medium stores a computer program code for recommending at least one of one or more workforces or crowdsourcing platforms for each of one or more tasks of a business workflow, the computer program code is executable by one or more processors to:
receive a plurality of business requirements corresponding to the business workflow;
receive one or more attributes associated with at least one of the one or more workforces or the crowdsourcing platforms; and
recommend at least one of the one or more workforces or the crowdsourcing platforms for each of the one or more tasks of the business workflow based on the plurality of business requirements and the one or more attributes.
